(19) United States
(12) Patent Application Publication
(10) Pub. No.: US 2024/0139733 A1
(43) Pub. Date: May 2, 2024

(54) GENERIC DESIGN FOR MICROFLUIDIC APPARATUS

(71) Applicant: PharmaFluidics NV, Zwijnaarde (BE)

(72) Inventors: Gert DESMET, Zemst (BE); Paul JACOBS, Lokeren (BE); Jeff OP DE BEECK, Mariakerke (BE); Bo CLAEREBOUT, Kortrijk (BE)

(21) Appl. No.: 18/568,613

(22) PCT Filed: Jun. 8, 2022
(86) PCT No.: PCT/IB2022/055314

§ 371 Date: Dec. 8, 2023

(30) Foreign Application Priority Data
Jun. 8, 2021 (BE) 2021/5457

(51) Int. Cl. B01L 3/00

(52) U.S. Cl. CPC B01L 3/502707; B01L 2300/0883; B01L 2400/086

(57) ABSTRACT

A method (200) for producing a microfluidic apparatus (100) according to one or more design constraints. The method comprises: providing (210) a first substrate (110) comprising multiple fluid channels (120), wherein the channels have an inlet (123) and an outlet (124); implementing (220) a configuration of connecting channels (150) on at least one second substrate (140) depending on the specified design constraints of the microfluidic apparatus (100); such that by aligning (230) the first substrate with the at least one second substrate, at least some inlets and outlets of the fluid channels of the first substrate are connected to the connecting channels (150) and a microfluidic device (100) complying with the one or more design constraints is obtained.

### SCOPE OF THE INVENTION

This invention generally relates to microfluidic devices. More specifically, the invention relates to a method for flexibly making microfluidic apparatuses which must comply with various requirements, and to microfluidic apparatuses obtained by such a method.

### BACKGROUND OF THE INVENTION

Microfluidic apparatuses using fluid propagation have a wide range of applications. Examples include: production of chemical components, synthesis of nanoparticles, separation and/or extraction of components, etc.

A specific example of a separation technique for separating mixtures in order to be able to analyse them accurately, for example, is chromatography. There is a variety of forms of chromatography such as gas chromatography, gel chromatography, thin layer chromatography, adsorption chromatography, affinity chromatography, liquid chromatography, etc.

Liquid chromatography is typically used in pharmacy and chemistry, both for analytical and production applications. Liquid chromatography utilises the difference in affinity of different substances with a mobile phase and a stationary phase. Since each substance has its own “adhesion” to the stationary phase, they are carried along faster or slower with the mobile phase, and in this way certain substances can be separated from others. It is in principle applicable to any compound, it has the advantage that no evaporation of the material is required and it has the advantage that variations in temperature have only a negligible effect.

An efficient form of liquid chromatography is high pressure liquid chromatography (also known as high performance liquid chromatography), HPLC, wherein high pressure is used in the separation process. A specific example of a technique for performing HPLC is based on pillar-based chromatographic columns.

Since being introduced into liquid chromatography, pillar-based chromatographic columns have proven to be a valuable alternative to systems based on packed bed structures and monolithic systems. Due to the option to arrange the pillars with a high degree of uniformity and to arrange them perfectly, the dispersion caused by differences in flow paths or “eddy dispersion” can be almost completely avoided. This principle is more generally applicable in chemical reactors that are based on liquid plug propagation.

Depending on the application, the microfluidic apparatuses have to comply with various requirements. These requirements may relate, for example, to flow rate, fluid velocity, flow resistance, analysis time, etc.

When requirements change, a new design for the microfluidic apparatus is required. This is, today, typically linked to a new mask design followed by the development of the lithographic and etching process and the associated costs.

Consequently, there is a need for a method for efficiently designing and producing microfluidic apparatuses that comply with one or more design constraints.

### SUMMARY OF THE INVENTION

It is an object of embodiments of the present invention to provide a good method for producing microfluidic apparatuses and to provide microfluidic apparatuses obtained according to such a method.

The aforementioned object is achieved by an apparatus, device and/or method according to the present invention.

In a first aspect, the present invention relates to a method for producing a microfluidic apparatus according to one or more design constraints.

The method comprises the following steps:
providing a first substrate comprising multiple fluid channels, wherein the channels have an inlet and an outlet,
implementing a configuration of connecting channels on at least one second substrate depending on the specified design constraints of the microfluidic apparatus,
such that by aligning the first substrate with the at least one second substrate, at least some inlets and outlets of the fluid channels of the first substrate are connected to the connecting channels and a microfluidic device complying with the one or more design constraints is obtained.

It is an advantage of the embodiments of the present invention that a single design of a substrate with fluid channels can be used to obtain multiple microfluidic apparatuses that comply with different design constraints.

In embodiments of the present invention, the first substrate is a silicon wafer.

In embodiments of the present invention, the at least one second substrate is a glass wafer or a silicon wafer. When the second substrate is a glass wafer, the advantage is that the alignment with such a wafer is easier to achieve than the alignment with a silicon wafer.

In embodiments of the present invention, the connecting channels are provided on a side of the second substrate which joins with the first substrate, and through-holes are provided in the second substrate for connecting an external appliance to inlets and outlets of the fluid channels on the first substrate. The external appliance may be, for example, a microchannel or another microfluidic apparatus.

In embodiments of the present invention, a design constraint of the one or more design constraints is a total channel length of the microfluidic apparatus.

In embodiments of the present invention, a design constraint is a flow resistance between an inlet and an outlet of the obtained microfluidic device. It is an advantage of embodiments of the present invention that a microfluidic apparatus can be designed to obtain a specific flow rate.

In embodiments of the present invention, pillars are arranged in the fluid channels of the provided first substrate.

In embodiments of the present invention, the fluid channels of the provided first substrate have the same shape.

In embodiments of the present invention, the fluid channels of the provided first substrate are substantially parallel to each other and are aligned with each other.

In embodiments of the present invention, the connecting channels are designed so as to interconnect at least a portion of the fluid channels of the first substrate in series.

In embodiments of the present invention, the connecting channels are designed so as to interconnect at least a portion of the fluid channels of the first substrate in parallel.

In embodiments of the present invention, the connecting channels are designed so as to interconnect at least a portion of the fluid channels of the first substrate in parallel and to interconnect at least a portion of the fluid channels in series.

In a second aspect, the present invention relates to a microfluidic apparatus. The microfluidic apparatus comprises:
a first substrate comprising multiple fluid channels, wherein the channels have an inlet and an outlet,
a configuration of connecting channels on at least one second substrate,
wherein the first substrate is aligned with the at least one second substrate such that at least some inlets and outlets of the fluid channels of the first substrate join with the connecting channels. It is an advantage of embodiments of the present invention that different microfluidic apparatuses can be obtained without having to modify the first substrate. It is sufficient to design new connecting channels such that the microfluidic apparatus obtained complies with the design constraints.

In embodiments of the present invention, pillars are present in fluid channels of the first substrate.

In embodiments of the present invention, the first substrate is a silicon wafer and the second substrate is a glass wafer or a silicon wafer.

Specific and preferred aspects of the invention are included in the appended independent and dependent claims. Features of the dependent claims may be combined with features of the independent claims and with features of other dependent claims as appropriate and not only as expressly presented in the claims.

These and other aspects of the invention will be apparent from, and clarified with reference to, the embodiment(s) described below.

### BRIEF DESCRIPTION OF THE FIGURES

FIG. 1 shows a schematic drawing of a microfluidic apparatus in accordance with embodiments of the present invention wherein the fluid channels are interconnected in series.

FIG. 2 shows a schematic drawing of a microfluidic apparatus in accordance with embodiments of the present invention wherein the fluid channels are interconnected in parallel.

FIG. 3 shows a schematic drawing of a microfluidic apparatus in accordance with embodiments wherein some of the connecting channels serve as access channels.

FIG. 4 shows an example of a microfluidic apparatus, in accordance with embodiments of the present invention, wherein unit structures consist of multiple interlinked fluid channels.

FIG. 5 shows an example of a microfluidic apparatus, in accordance with embodiments of the present invention, wherein unit structures are coupled in series.

FIG. 6 shows an example of connecting channels and through-openings made in a glass substrate suitable for the microfluidic apparatus shown in FIG. 1.

FIG. 7 shows an example of connecting channels made in a glass substrate suitable for the microfluidic apparatus shown in FIG. 3.

FIG. 8 shows some cross-sections and a top view of a microfluidic apparatus in accordance with embodiments of the present invention.

FIG. 9 shows an embodiment of the present invention wherein a capillary is arranged in an access channel.

FIG. 10 shows schematic drawings of a through-hole in the second substrate which joins with an inlet or outlet in the second substrate.

FIG. 11 shows a schematic drawing of two microfluidic devices stacked on top of each other, in accordance with embodiments of the present invention.

FIG. 12 shows a second substrate on which some connecting channels are arranged, in accordance with embodiments of the present invention.

FIG. 13 shows an enlarged drawing of the detail “A” in FIG. 12.

FIG. 14 shows schematic drawings of typical alignment structures.

FIG. 15 shows a flow chart of an exemplary method in accordance with embodiments of the present invention.

The figures are only schematic and not limiting. In the figures, the dimensions of some parts may be exaggerated and not to scale for illustrative purposes.

Reference numbers in the claims should not be interpreted as limiting the scope of protection. In the various figures, the same reference numbers refer to the same or similar elements.

### DETAILED DESCRIPTION OF ILLUSTRATIVE EMBODIMENTS

The present invention will be described with respect to particular embodiments and with reference to certain drawings; however, the invention is not limited thereto but is limited only by the claims. The drawings described are only schematic and not limiting. In the drawings, for illustrative purposes, the dimensions of some elements may be enlarged and not drawn to scale. The dimensions and relative dimensions sometimes do not correspond to the actual practical implementation of the invention.

Furthermore, the terms “first”, “second”, “third” and the like are used in the description and in the claims for distinguishing similar elements and not necessarily for describing an order, whether in time, spatially, in rank or in any other way. It is to be understood that the terms used in this manner are interchangeable under suitable circumstances and that the embodiments of the invention described herein are suitable for operating in a different order than that described or set forth herein.

Moreover, the terms “top”, “bottom”, “above”, “in front of” and the like in the description and the claims are employed for descriptive purposes and not necessarily to describe relative positions. It should be understood that the terms thus employed may be interchangeable under given circumstances and that the embodiments of the invention described herein are also suitable for operating according to other orientations than those described or set forth herein.

It should be noted that the term “comprises”, as used in the claims, is not to be interpreted as limited to the means described thereafter; this term does not preclude other elements or steps. It is therefore to be interpreted as specifying the presence of the indicated features, values, steps or components referred to, but does not preclude the presence or addition of one or more other features, values, steps or components, or groups thereof. Thus, the scope of the expression “a device comprising means A and B” should not be limited to devices consisting only of components A and B. It means that with respect to the present invention, A and B are the only relevant components of the device.

Reference throughout this specification to “one embodiment” or “an embodiment” means that a specific feature, structure or characteristic described in connection with the embodiment is included in at least one embodiment of the present invention. Thus, the occurrence of the expressions “in one embodiment” or “in an embodiment” in various places throughout this specification does not necessarily refer to the same embodiment each time, but may do so. Further, the specific features, structures or characteristics may be combined in any suitable manner as would be apparent to an average skilled person on the basis of this disclosure, in one or more embodiments.

Similarly, it should be appreciated that in the description of exemplary embodiments of the invention, various features of the invention are sometimes grouped together into one single embodiment, figure or description thereof for the purpose of streamlining the disclosure and assisting in the understanding of one or more of the various inventive aspects. In any event, this method of disclosure should not be interpreted as reflecting an intention that the invention requires more features than are explicitly mentioned in each claim. Rather, as the following claims reflect, inventive aspects are found in less than all features of a single previously disclosed embodiment. Thus, the claims following the detailed description are hereby explicitly included in this detailed description, with each stand-alone claim being a separate embodiment of this invention.

Further, while some embodiments described herein comprise some, but not other, features included in other embodiments, combinations of features of different embodiments are intended to lie within the scope of the invention, and constitute these different embodiments, as would be understood by the skilled person. For example, in the following claims, any of the described embodiments may be used in any combination.

Numerous specific details are set out in the description provided here. In any event, it is understood that embodiments of the invention may be implemented without these specific details. In other cases, well-known methods, structures and techniques have not been shown in detail in order to keep this description clear.

In a first aspect, the present invention relates to a method 200 for producing a microfluidic apparatus 100 according to one or more design constraints. The design constraints can be chosen, for example, from the following non-limiting list: total channel length, flow resistance, flow rate, fluid velocity, analysis time.

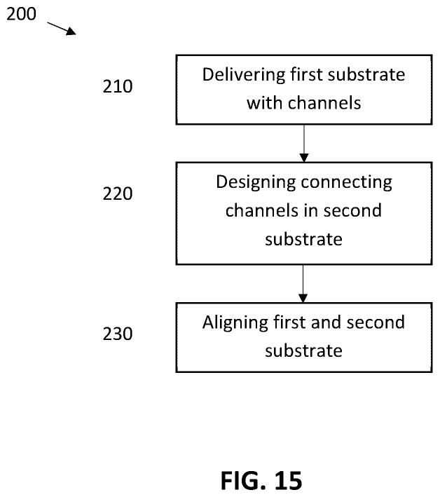

FIG. 15 shows a flow chart of an exemplary method in accordance with embodiments of the present invention.

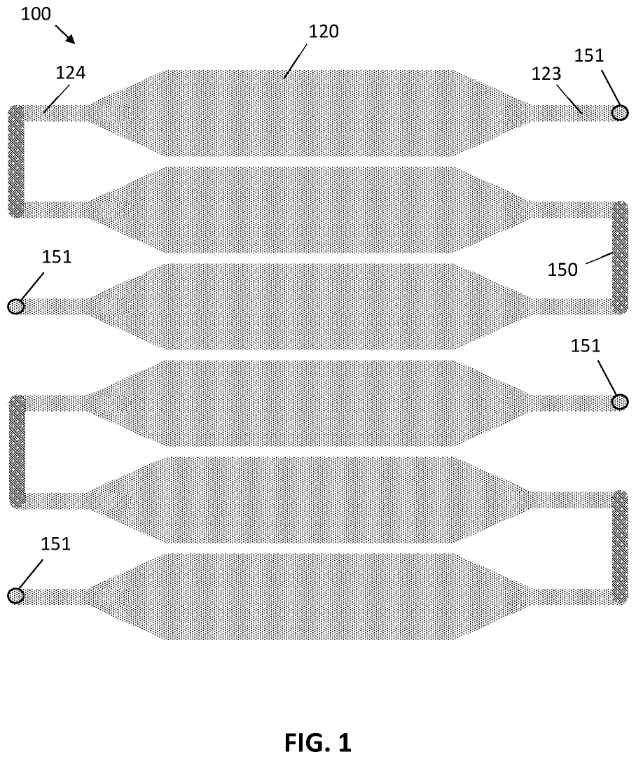

In a second aspect, the present invention relates to a microfluidic apparatus. Such a microfluidic apparatus can be obtained by performing a method according to the present invention. FIG. 1 to FIG. 5 show schematic drawings of microfluidic apparatuses, or parts thereof, in accordance with embodiments of the present invention.

A method 200 according to embodiments of the present invention comprises providing 210 a first substrate 110 comprising multiple fluid channels 120, wherein the channels have an inlet 123 and an outlet 124.

The method further comprises implementing 220 a configuration of connecting channels 150 on at least one second substrate 140 depending on the specified design constraints of the microfluidic apparatus 100.

The method further comprises aligning 230 the first substrate with the at least one second substrate. The fluid channels and the connecting channels are designed such that after the first substrate is aligned with the at least one second substrate, at least some inlets and outlets of the fluid channels of the first substrate are connected to the connecting channels 150 and a microfluidic device 100 complying with the one or more design constraints is obtained. After alignment, the first substrate and the second substrate are bonded together.

A microfluidic apparatus according to embodiments of the present invention comprises a first substrate 110 comprising multiple fluid channels 120, wherein the channels have an inlet 123 and an outlet 124,
a configuration of connecting channels 150 on at least one second substrate 140,
wherein the first substrate is aligned with the at least one second substrate such that at least some inlets and outlets of the fluid channels of the first substrate join with the connecting channels 150.

FIG. 1 shows a schematic drawing of a microfluidic apparatus in accordance with embodiments of the present invention. In this figure, a portion of the fluid channels 120 are interconnected in series by the connecting channels 150. In this example, the connecting channels 150 are located on that side of the second substrate that is in contact with the first substrate. In this example, through-holes 151 are provided which on one side join directly or indirectly with an inlet 123 or outlet 124 and with which an external appliance can be joined on the other side. A through-hole may be joined, for example, with a connecting channel which joins with an inlet 123 or outlet 124. The diameter of the through-holes may be, for example, between 10 μm and 1000 μm, for example between 20 μm and 500 μm. The through-holes may for example have a diameter of 40 μm.

In embodiments of the present invention, the connecting channels are designed so as to interconnect at least a portion of the fluid channels of the first substrate in parallel. A connecting channel may, for example, split into several connecting channels each leading to a different inlet of another connecting channel. On the other hand, several connecting channels, each of which is connected to a different outlet, may converge into a common channel.

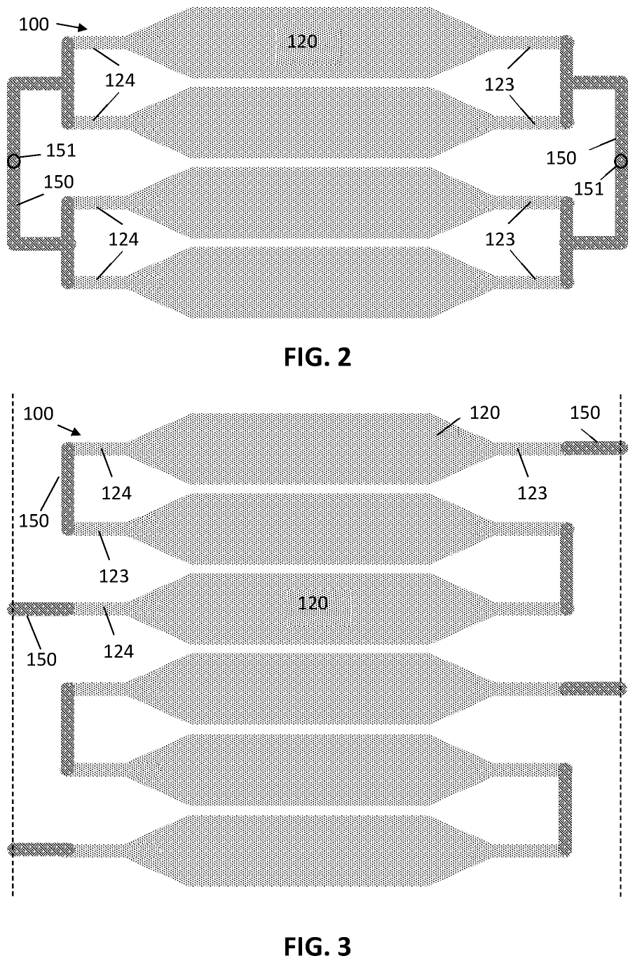

FIG. 2 shows a schematic drawing of a microfluidic apparatus in accordance with embodiments of the present invention. In this figure, the connecting channels 150 are designed so as to interconnect the fluid channels 120 of the first substrate in parallel. In this example, all fluid channels 120 are interconnected in parallel. However, this is not strictly necessarily the case. It is also possible for a portion of the fluid channels to be interconnected in parallel. Combinations of series and parallel connections are also possible.

FIG. 3 shows a schematic drawing of a microfluidic apparatus in accordance with embodiments of the present invention. In this figure, the fluid channels are interconnected in series. In addition, connecting channels 150 are also present which serve as access channels to the inlet 123 or outlet 124. See, for example, the connecting channel in the upper right corner of FIG. 3 and the connecting channel 150 connected to the outlet 124 of the third (counted from the top) fluid channel 120. These access channels may be opened, for example, by “dicing”. This can be done, for example, by sawing with a diamond saw or by laser cutting. The vertical dotted lines on the left and right sides of FIG. 3 indicate where the sawing lines might lie, for example. Access to the connecting channels 150 is provided by cutting/sawing along the dotted lines. This can also be done by partially sawing and then breaking to prevent coolant and debris from being introduced into the side channels.

In embodiments of the present invention, the fluid channels of the provided first substrate are substantially parallel to each other and are aligned with each other. The fluid channels are, for example, parallel to each other for most of their length. The side walls or the central shafts are, for example, parallel to each other.

The examples of FIG. 1 to FIG. 5 are obtained by providing a first substrate on which a series of parallel fluid channels are arranged. On a second substrate, connecting channels 150 are arranged on one side of the substrate. By aligning the first substrate with respect to the second substrate and arranging the two substrates against each other, the parallel fluid channels are interconnected by the connecting channels.

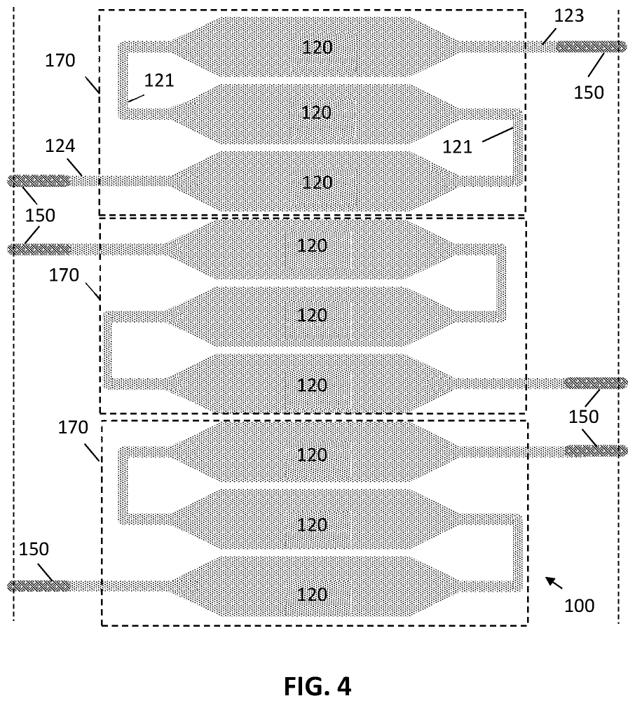

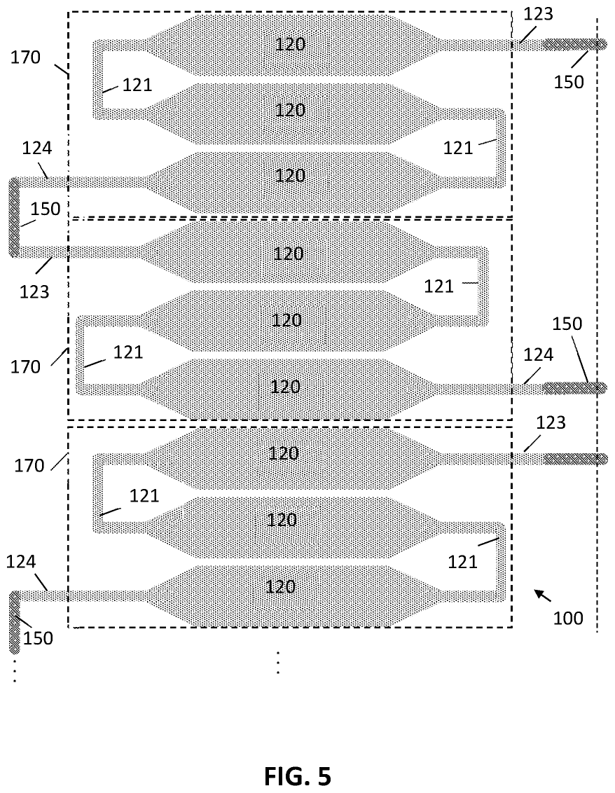

FIG. 4 and FIG. 5 show microfluidic apparatuses 100, in accordance with embodiments of the present invention, wherein unit structures 170 consist of multiple interlinked fluid channels 120. In FIG. 4 the bottom and top unit structures 170 are identical. The unit structures are formed in the first substrate and the connecting channels 150 are formed in the second substrate. Linking channels 121 between fluid channels of a unit structure are formed in the first substrate. Some connecting channels 150 are connected to an inlet 123 of a fluid channel 120 and some connecting channels 150 are connected to an outlet 124 of a fluid channel. The vertical dotted lines on the left and right sides of FIG. 4 show the sawing lines.

In FIG. 5, the two top unit structures 170 are interconnected in series by a connecting channel 150. In other embodiments of the present invention, the unit structures may also be interconnected in parallel. An inlet 123 of the series-coupled unit structures is connected to a connecting channel 150 and an outlet 124 of the series-coupled unit structures is connected to a connecting channel 150. Linking channels 121 connect the fluid channels 120 of a unit structure 120. The vertical dotted line on the right side of FIG. 5 shows a sawing line.

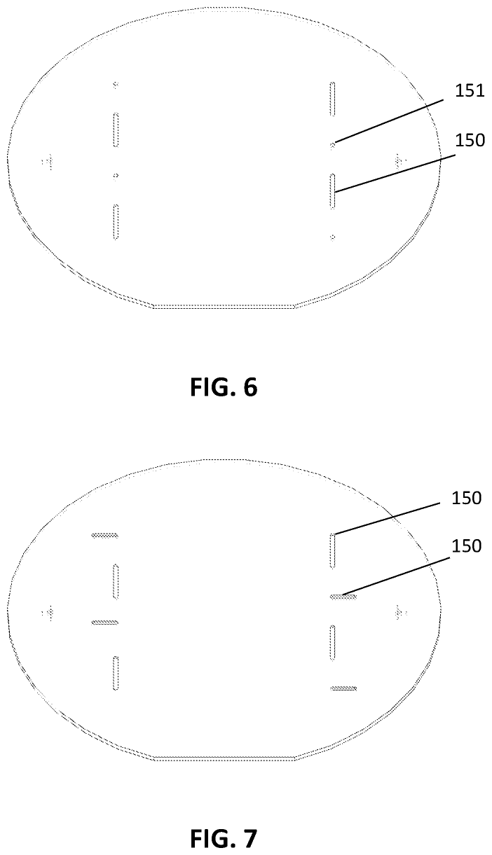

The connecting channels 150 may be made in various types of substrates. The connecting channels 150 can be made in a glass substrate 140, for example. As previously discussed, these can be channels interconnecting the fluid channels and can also be access channels providing access to the fluid channels of the microfluidic apparatus. An example of connecting channels 150 and through-openings 151 made in a glass substrate is shown in FIG. 6. This configuration is suitable for obtaining a microfluidic apparatus as shown in FIG. 1. FIG. 7 shows an example of connecting channels 150 made in a glass substrate suitable for the microfluidic apparatus shown in FIG. 3.

Connecting channels can be made in the second substrate, for example, by a combination of lithography and etching. Etching can in this case be done in wet conditions. This etching is typically isotropic, which means that the underside of the channels have a semi-cylindrical cross-section. Alternatively, dry etching can be applied. These channels will typically have a rectangular cross-section.

Connecting channels can optionally also be made by selective laser-induced etching. The properties of the glass are locally altered (softened) with a laser in such a way that it can be selectively chemically etched. This gives a high degree of control over the channel shapes.

In yet another embodiment of the present invention, the connecting channels can be formed by “femtosecond laser direct writing” (FsLDW).

Through-holes can be made in the same way. Optionally, laser ablation (although less precise), sandblasting (even less precise) or micro-waterjet ablation can also be used as techniques to make the through-holes.

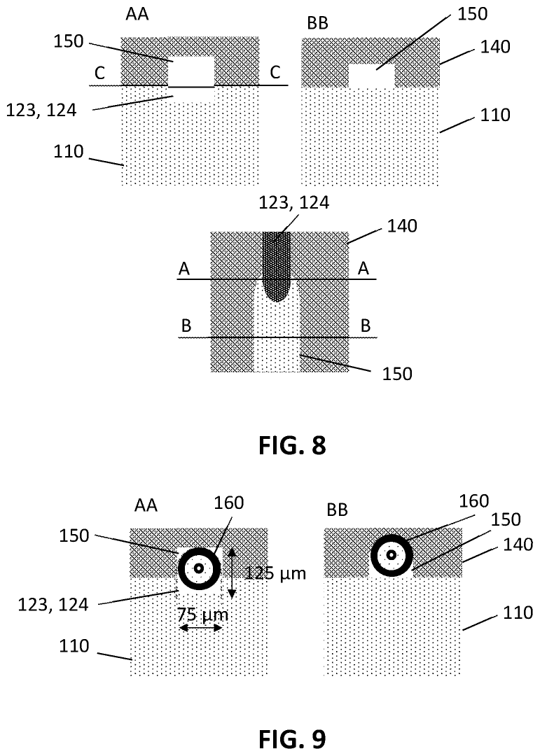

FIG. 8 shows a schematic drawing of a microfluidic apparatus in accordance with embodiments of the present invention. The microfluidic apparatus comprises a connecting channel 150 which is arranged in the second substrate 140 and which joins with an inlet 123 or outlet 124 of a fluid channel.

The top drawings in FIG. 8 show cross-sections AA and BB of the microfluidic apparatus. The location of these cross-sections is indicated in the bottom drawing. This drawing shows the parallel cross-section CC. The top left figure shows the inlet/outlet 123, 124 on the first substrate and the access channel 150. Both are aligned with respect to each other. The top right figure is further into the access channel and shows only the access channel 150.

FIG. 9 shows an embodiment wherein a capillary 160 is arranged in an access channel 150. A capillary may for example be made of quartz glass (“fused silica”). In this example, the width of the access channel 150 and of the inlets 123 and outlets 124 is equal to 75 μm. The invention is not limited thereto, however. In general, the width may be, for example, between 5 and 1000 μm. The total height of the inlet/outlet and the access channel and the height of the access channel at a position further down where there is only the access channel are the same in this example. In this example the height is 125 μm. The invention is not limited thereto, however. The height of the access channel or the total height of the inlet/outlet and the access channel may in general be, for example, between 100 and 1500 μm.

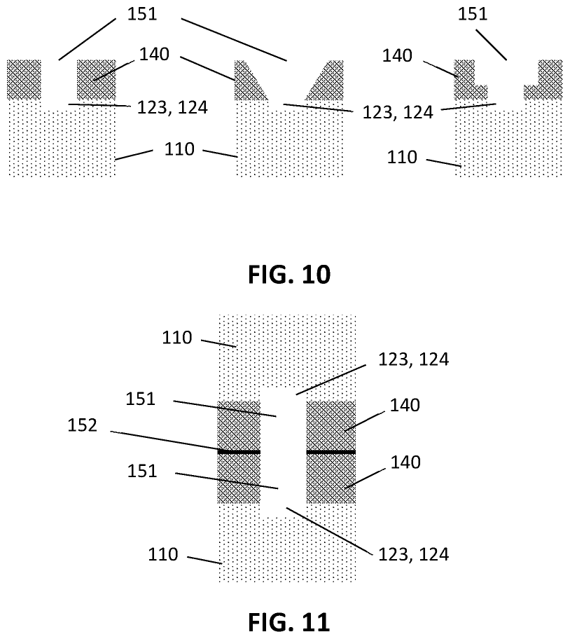

FIG. 10 shows schematic drawings of a cross-section of a through-hole 151 in the second substrate 141 joining with an inlet or outlet 123,124 in the second substrate 110.

FIG. 11 shows a schematic drawing of two microfluidic devices whose through-holes 151 join with each other. In this figure, two microfluidic apparatuses are stacked on top of each other. A seal 152 is present between the second substrate 140 of one microfluidic apparatus and the second substrate 140 of the other microfluidic apparatus. This can be, for example, a reversible seal made of, for example, polyetheretherketone (PEEK), Teflon or polyimide. The first substrate 110 of both microfluidic devices may be, for example, a silicon substrate.

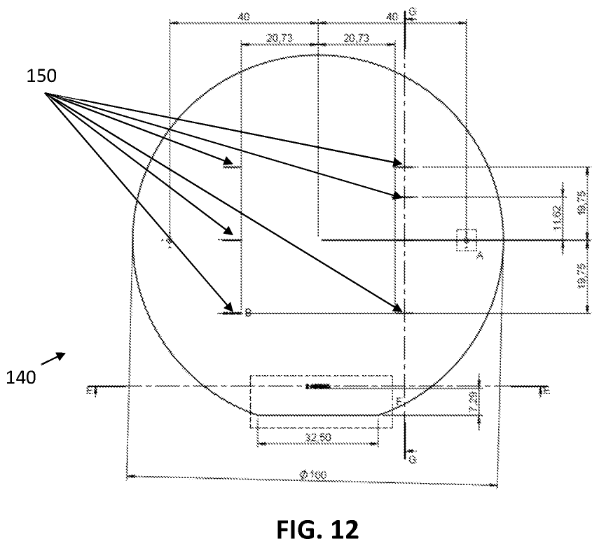

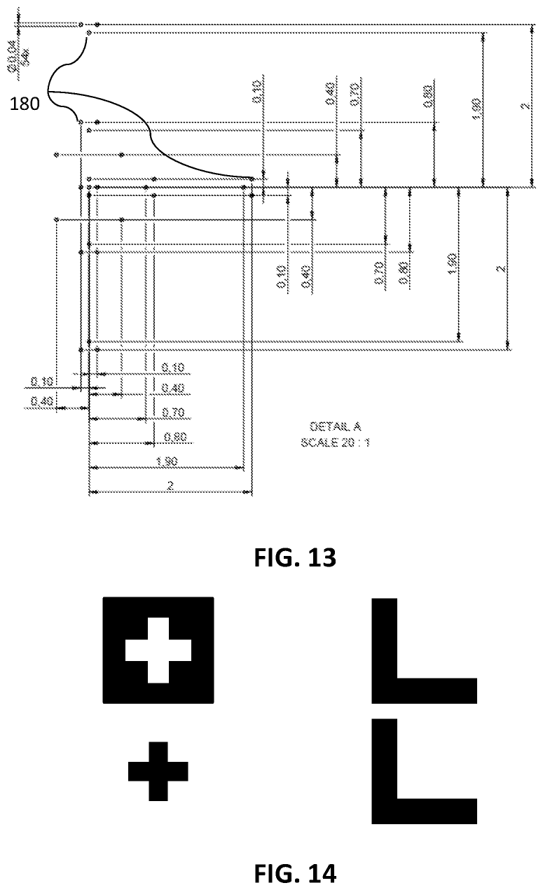

In a method according to embodiments of the present invention, the first and second substrates are aligned relative to each other such that at least some inlets 123 and outlets 124 of the fluid channels 120 of the first substrate are connected to the connecting channels 150. The first and second substrates may, for example, be aligned relative to each other using optical alignment. FIG. 12 shows a second substrate 140 which in this case is a glass wafer. Connecting channels 150 are present in this substrate. Section A in this figure comprises an alignment structure. An enlargement thereof is shown in FIG. 13. In this example, the alignment structure comprises a number of holes 180 arranged in a pattern. Only a limited number of reference lines 180 are provided in this drawing so as not to overload the drawing. In embodiments of the present invention, this pattern is also arranged in the first substrate so that both can be aligned with each other. In this example, the pattern formed is a T-pattern. The dimensions indicated in this figure are expressed in mm.

In this example, the second substrate is a wafer made of borosilicate glass. It has a diameter of 4 inches and a thickness of 700 μm. The invention is not limited thereto, however.

In general, the diameter of the wafer for the second substrate may be, for example, between 5 cm and 30 cm and the thickness may be, for example, between 0.2 mm and 5 mm.

In general, the diameter of the wafer for the first substrate may be, for example, between 5 cm and 30 cm. and the thickness may be, for example, between 0.2 mm and 2 mm.

Optical wafer-to-wafer alignment methods are known in the industry (e.g. ref: ‘Wafer-to-wafer Alignment for Three-Dimensional Integration: A Review’, Journal of Microelectromechanical Systems, Vol. 20, No. 4, August 2011): Optical microscopy-based aligners.

FIG. 14 shows schematic drawings of typical alignment structures. The top alignment structures can for example be arranged in the first substrate and the bottom alignment structures in the second substrate.

Optionally, the alignment between the first and second substrates can also be done mechanically.

In embodiments of the present invention, the fluid channels 120 in the first substrate are pillar-based separation channels.

The first substrate may be, for example, a silicon substrate. It may be, for example, a doped or non-doped silicon substrate. It may be, for example, a highly doped p++ substrate.

The second substrate is chosen so that, on the one hand, channels can be made therein and, on the other hand, bonding with the first substrate can be done in a reliable manner.

The second substrate may be made, for example, of glass. More specifically, it may be made, for example, of borosilicate. In other embodiments of the present invention, the second substrate may be a silicon substrate. The bonding with the first substrate may in that case be done, for example, by direct wafer bonding (“fusion bonding”), wherein the first and second substrates are bonded without additional intermediate layers but by chemical bonds between the material of the first substrate and the material of the second substrate.

It is an advantage of embodiments of the present invention that a large number of different products can be made with only one or a limited number of designs. For example, the same wafer can be used each time for the first substrate with the fluid channels, thus reducing the cost per wafer.

In embodiments of the present invention, a plurality of fluid channels 120 (e.g. separation channels) are made on the first substrate. These fluid channels may, for example, all be parallel to each other, wherein the ends of the fluid channels are in a line on each side. These fluid channels may, for example, all have the same shape. In that case they are also called unit structures. A unit structure may consist of one fluid channel or may consist of multiple fluid channels interconnected in the first substrate. Multiple identical unit structures may be present on the first substrate. Connections between the unit structures may be made by the connecting channels in the second substrate.

The length of a fluid channel 120 may be, for example, between 5 and 30 cm.

The width of a fluid channel 120 may vary for example between 100 μm and 5,000 μm or for example between 500 μm and 10,000 μm.

The distance between the most closely spaced walls of the fluid channels may vary, for example, between 50 μm and 1000 μm. In embodiments of the present invention, the distance between two unit structures is measured between the most closely spaced walls of the most closely spaced fluid channels. This distance may vary, for example, between 50 μm and 1000 μm.

Using methods according to embodiments of the present invention, it is possible to provide access to fluid channels 120 and to interconnect fluid channels 120 by means of connecting channels. In the first case, these connecting channels are access channels. In the second case, fluid channels are interconnected in parallel and/or in series. Up to 50 inlets and up to 50 outlets can be interconnected in parallel, for example. In other words, in this example, one design of fluid channels of the first substrate is sufficient to create a large number of different products by only changing the design of the connecting channels each time.

1. A method for producing a microfluidic apparatus according to one or more design constraints, the method comprising:
providing a first substrate comprising multiple fluid channels, wherein the channels have an inlet and an outlet,
implementing a configuration of connecting channels on at least one second substrate depending on the specified design constraints of the microfluidic apparatus,
such that by aligning the first substrate with the at least one second substrate, at least some inlets and outlets of the fluid channels of the first substrate are connected to the connecting channels and a microfluidic device complying with the one or more design constraints is obtained.

2. A method according to claim 1, wherein the first substrate is a silicon wafer.

3. A method according to claim 1, wherein the at least one second substrate is a glass wafer or a silicon wafer.

4. A method according to claim 1, wherein the connecting channels are implemented on that side of the second substrate which joins with the first substrate.

5. A method according to claim 4, wherein through-holes are arranged in the second substrate for connection with inlets and outlets of the fluid channels on the first substrate.

6. A method according to claim 1, wherein a design constraint of the one or more design constraints is a total channel length of the microfluidic apparatus and/or wherein a design constraint of the one or more design constraints is a flow resistance between an inlet and an outlet of the obtained microfluidic device.

7. A method according to claim 1, wherein pillars are present in fluid channels of the provided first substrate.

8. A method according to claim 1, wherein the fluid channels of the provided first substrate have the same shape.

9. A method according to claim 1, wherein the fluid channels of the provided first substrate are substantially parallel and aligned with each other.

10. A method according to claim 1, wherein the connecting channels are designed so as to interconnect at least a portion of the fluid channels of the first substrate in series.

11. A method according to claim 1, wherein the connecting channels are designed so as to interconnect at least a portion of the fluid channels of the first substrate in parallel.

12. A method according to claim 1, wherein the connecting channels are designed so as to interconnect at least a portion of the fluid channels of the first substrate in parallel and interconnect at least a portion of the fluid channels in series.

13. A microfluidic apparatus, the microfluidic apparatus comprising:
a first substrate comprising multiple fluid channels, wherein the channels have an inlet and an outlet,
a configuration of connecting channels on at least one second substrate,
wherein the first substrate is aligned with the at least one second substrate such that at least some inlets and outlets of the fluid channels of the first substrate join with the connecting channels.

14. A microfluidic apparatus according to claim 13, wherein pillars are present in fluid channels of the first substrate.

15. A microfluidic apparatus according to claim 1, wherein the first substrate is a silicon wafer and wherein the second substrate is a glass wafer or a silicon wafer.
